(19) United States
(12) Patent Application Publication
(10) Pub. No.: US 2006/0199150 A1
(43) Pub. Date: Sep. 7, 2006

(54) Externally-threaded, one-piece endosseous dental implant with angled abutment

(76) Inventor: Gerald A. Niznick, Las Vegas, NV (US)

Correspondence Address: Patrick F. Bright, Esq.;BRIGHT & LORIG, P.C., Suite 3330, 633 West Fifth Street, Los Angeles, CA, 90071, US

(21) Appl. No.: 11/074,051

(22) Filed: Mar. 7, 2005

(51) Int. Cl. A61C 8/00

(52) U.S. Cl. 433/173

(57) ABSTRACT

An externally-threaded, one-piece endosseous dental implant including an angled, proximal portion that functions as an abutment for cemented restorations.

This invention relates to externally-threaded, one-piece endosseous dental implants and more particularly, to such implants that accept cemented prosthetic restorations, and that include an angled proximal portion that functions as an abutment. The body of these implants may be at least partly externally threaded, and may include two or more threaded regions, in which the spacing between the flights of the threads in one region differ from the spacing in another region, as disclosed, for example, in co-pending U.S. patent application Ser. No. 11/047,959, filed Jan. 31, 2005, in the PTO, and entitled, “Tapered Endosseous Dental Implants With External Multiple Lead Threads” (Atty. Docket No. D9473). This disclosure is incorporated in its entirety as though fully set forth herein.

In some embodiments, the body of the implant may taper, in whole or in part, from the proximal end toward the distal end of the implant. The external surface of the body portion of these implants may also include, proximal to the threaded regions, one or more unthreaded cylindrical regions, and a proximal, circumferentially scalloped region.

Preferred embodiments of these one-piece implants include an internal passage that begins at an opening formed at or near the proximal end of the implant, in the angled proximal portion, and extends distally inside the implant, terminating inside the implant. Inside this passage may be multi-sided, multi-lobed, or other multiple surface regions, generally denoted wrench-engaging surfaces, to engage a tool for holding, twisting, turning or inserting the implant in an opening formed in the jawbone of a patient to receive the implant.

The abutment portion angles from the front, or cheek side of the implant, towards the back, or tongue side, of the implant, and tapers inwards towards the proximal end of the implant. The implant may include a scalloped region distal to the abutment position. This scalloped region, on the external surface of the implant, serves as a finishing margin for a cemented restoration. This proximal scalloped region may form a flat or curved surface that extends upwardly, on one side of the implant, from the front of the implant towards the back of the implant, and then extends downwardly from the back to the front of the implant on the other side of the implant. From the front, or low point, to the back, or high point, the scalloped region may measure from about 1 mm to about 3 mm, e.g., about 2 mm.

The proximal portion of the implant that functions as an abutment may comprise about 33% to about 50% of the linear length of the implant, tilts toward the back of the implant, and may form an angle in the range of about 50 to about 15°, measured from a plane normal to the longitudinal axis of the body of the implant. The abutment portion of the implant may be tapered in shape. The distal end of the abutment portion of the implant, at the front, may also include an undercut, e.g., a semi-circular undercut.

Some embodiments of these implants may include a partly or wholly circumferential groove formed in the external surface of the body of the implant, preferably located on the abutment region, of sufficient size and shape to engage a protrusion on the inner surface of a snap-on comfort cap or a snap-on transfer. These caps/transfers include a cylindrical distal portion of size and shape complementary to the size and shape of the proximal end of the implant, and have a wholly or partly circumferential protrusion inside the cylindrical distal portion that seat in the groove in the implant.

These implants may also include one or more of the features of the endosseous dental implants, abutments and other related products, disclosed in the following U.S. Patent Applications:
U.S. patent application Ser. No. 11/047,960, filed Jan. 31, 2005 in the PTO, entitled “Externally-Threaded Endosseous Dental Implants With Internal Abutment-Engaging And Fixture Mount-Engaging Surfaces” (Atty. Docket No. D9471);
U.S. patent application Ser. No. 11/047,959, filed Jan. 31, 2005 in the PTO, entitled “Tapered Endosseous Dental Implants With External Multiple Lead Threads” (Atty. Docket No. D9473);
U.S. patent application Ser. No. 10/877,460, filed Jun. 25, 2004 in the PTO, entitled “Endosseous Dental Implant” (Atty. Docket No. D9462);
U.S. patent application Ser. No. 10/883,275, filed Jul. 1, 2004 in the PTO, entitled “Endosseous One-Piece Screw-Type Dental Implants” (Atty. Docket No. D9456);
U.S. patent application Ser. No. 10/741,023, filed Dec. 19, 2003 in the PTO, entitled “Multi-part Abutment And Transfer Cap For Use With An Endosseous Dental Implant With Non-Circular, Beveled Implant Abutment Interface” (Atty. Docket No. D9452);
U.S. patent application Ser. No. 10/741,061, filed Dec. 19, 2003 in the PTO, entitled “Endosseous Dental Implant” (Atty. Docket No. D9443); and
U.S. Pat. No. 4,960,381, issued Oct. 2, 1990, entitled “Screw-Type Dental Implant Anchor.”

### BRIEF DESCRIPTION OF THE DRAWINGS

The angled, one-piece endosseous dental implants may better be understood by reference to the drawings, in which:

FIG. 1 is a front elevation view of an embodiment of a one-piece endosseous dental implant, including an angled abutment portion at its proximal end;

FIG. 2 is a side elevation view in partial cross-section of the dental implant of FIG. 1, showing the longitudinal, internal passage inside the implant with multi-sided wrench-engaging surfaces inside this internal passage;

FIG. 3 is a plan perspective view of the implant of FIGS. 1 and 2;

FIG. 4 is a rear elevation view, in partial cross-section, of the implant shown in FIGS. 1-3;

FIG. 5 is a side elevation view, in partial cross-section, of the implant shown in FIGS. 1-4;

FIG. 6 is a side elevation view of another embodiment of a one-piece endosseous dental implant, including an angled abutment portion at its proximal end, with a horizontal shoulder below the angled abutment portion;

FIG. 7 is a side elevation view of yet another embodiment of a one-piece endosseous dental implant, including an angled abutment portion at its proximal end, with a sloped shoulder below the angled abutment portion;

FIG. 8 is a side elevation view of another embodiment of a one-piece endosseous dental implant, including an angled abutment portion at its proximal end, and with no shoulder below the angled abutment portion;

FIG. 9 is a side elevation view of another embodiment of a one-piece endosseous dental implant, including an angled abutment portion at its proximal end, with the angled abutment portion including external, opposed wrench-engaging grooves; and

FIG. 10 is a perspective view of the implant of FIG. 9.

### DETAILED DESCRIPTION OF THE DRAWINGS

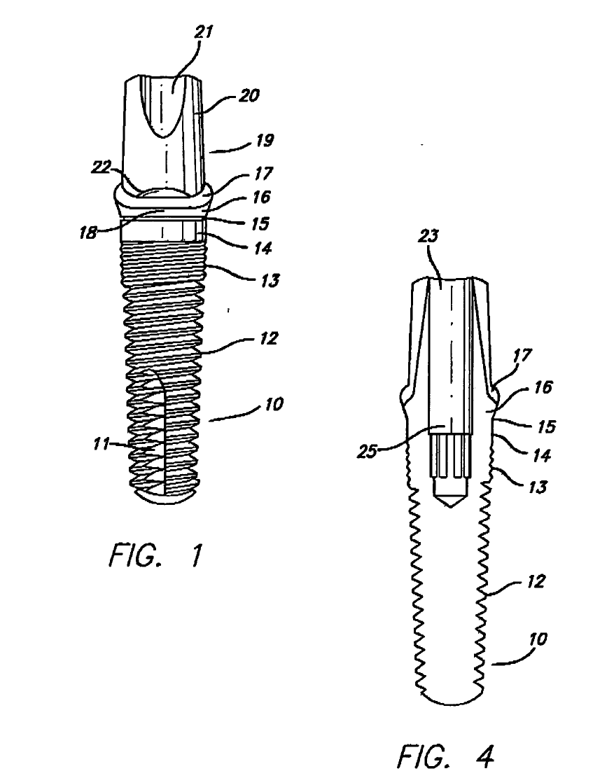

FIG. 1 shows a side elevation view of externally-threaded, tapered, one-piece endosseous dental implant 10. Implant 10 includes, on its external surface, self-tapping cutting region 11, first threaded region 12, and second threaded region 13. The distance between the thread flights in section 12 is approximately twice that of the distance between the threads in section 13. Proximal to section 13 is cylindrical, unthreaded external body portion 14 and circumferential groove 15.

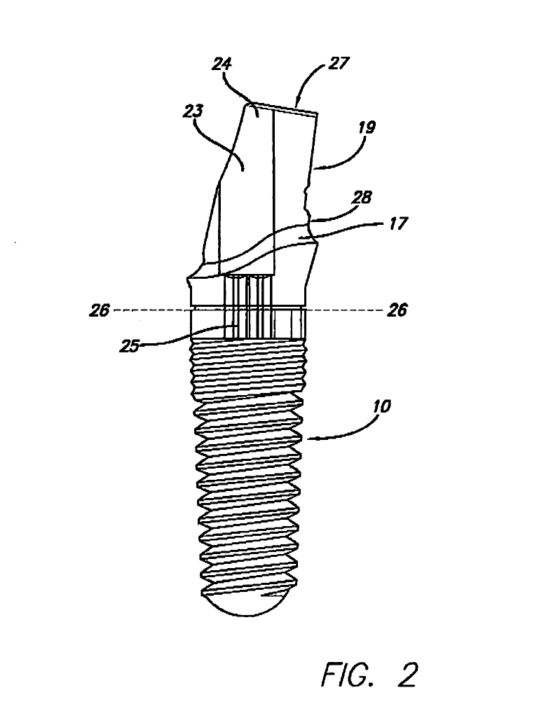

Proximal to circumferential groove 15 is proximal, scalloped region 16 that includes flat shoulder 17 that extends proximally and upwardly from the front 18 of the implant 10 toward the back of implant 10, and, from there, that extends distally downwardly toward the front of implant 10 from the back. The back of the scalloped region 17 lies on line 28. (See FIG. 2.)

Atop implant 10, and integral therewith, is angled head portion 19 that functions as an abutment. Portion 19 includes tapered external surfaces 20. Cutouts in surface 20 include tapered groove 21, and semi-circular grooves 22 and 22B. Grooves 22A and 22B are of size and shape to receive a snap-on transfer or snap-on comfort cap, such as those described above at page 3:9-12

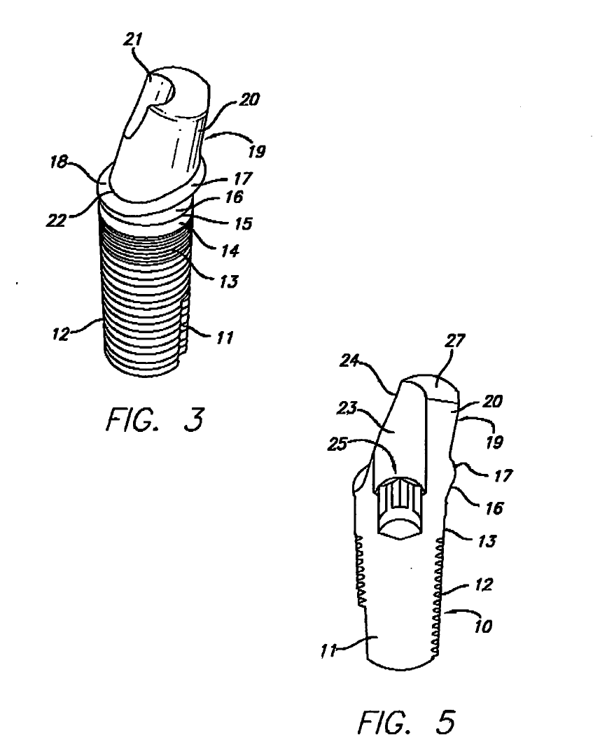

FIGS. 2, 3, 4 and 5 show that implant 10 includes internal passage 23 that extends distally inside implant 10 from opening 24, near the proximal end of implant 10, and terminates inside the body of implant 10, with multi-sided wrench-engaging surfaces 25 formed near the distal end of internal passage 23. These multi-sided surfaces 25 are suitable for receiving and engaging a tool for twisting, turning, holding or inserting implant 10 into an opening formed in the jawbone of a patient to receive implant 10.

Abutment portion 19 forms an angle of approximately 10° with respect to an imaginary plane formed at a right angle to the longitudinal axis of implant 10, such as the plane on line 26-26. The proximal end of implant 10 is flat surface 27.

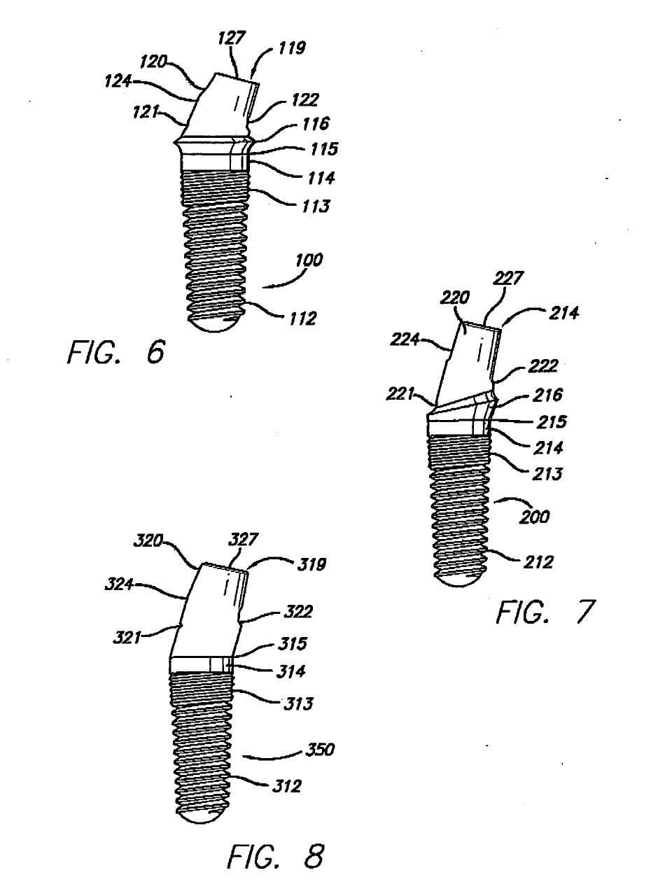

FIG. 6 shows a side elevation view of another embodiment of an externally-threaded, tapered, one-piece endosseous dental implant 100. Implant 100 includes, on its external surface, first threaded region 112 and second threaded region 113. The distance between the thread flights in section 112 is approximately twice that of the distance between the threads in section 113. Proximal to section 113 is cylindrical, unthreaded external body portion 114 and circumferential groove 115.

Proximal to circumferential groove 115 is proximal, horizontal shoulder 116. Proximal to shoulder 116, atop implant 100, and integral therewith, is angled head portion 119 that function as an abutment. Portion 119 includes a tapered external surface 120 with cutouts/grooves 121 and 122, that are of size and shape to receive a snap-on transfer or snap-on comfort cap, such as those described above at page 3:9-12. Like the implant shown in FIGS. 1-5, implant 100 includes an internal passage that extends distally inside the implant 100 from an opening 124, near the proximal end of implant 100, and terminates inside the body of implant 100, with multi-sided, wrench-engaging surfaces formed near the distal end of the internal passage. These multi-sided surfaces are suitable for receiving and engaging a tool for twisting, turning, holding or inserting implant 100 into an opening formed in the jawbone of a patient to receive implant 100.

Abutment portion 119 forms an angled of approximately 10° with respect to imaginary plane formed at a right-angled longitudinal axis of implant 100. The proximal end of implant 100 is flat surface 127.

FIG. 7 shows a side elevation view of externally-threaded, tapered, one-piece endosseous dental implant 200. Implant 200 includes, on its external surface, first threaded region 212 and second threaded region 213. The distance between the thread flights in section 212 is approximately twice that of the distance between the threads in section 213. Proximal to section 213 is cylindrical, unthreaded external body portion 214 and circumferential groove 215.

Proximal to circumferential groove 215 is proximal, slanted shoulder 216. Proximal to shoulder 216, atop implant 200, and integral therewith, is angled head portion 219 that function as an abutment. Portion 219 includes a tapered external surface 220 with cutouts/grooves 221 and 222, that are of size and shape to receive a snap-on transfer or snap-on comfort cap, such as those described above at page 3:9-12. Like the implant shown in FIGS. 1-5, implant 200 includes an internal passage that extends distally inside the implant 200 from an opening 224, near the proximal end of implant 200, and terminates inside the body of implant 200, with multi-sided, wrench-engaging surfaces formed near the distal end of the internal passage. These multi-sided surfaces are suitable for receiving and engaging a tool for twisting, turning, holding or inserting implant 200 into an opening formed in the jawbone of a patient to receive implant 200.

Abutment portion 219 forms an angled of approximately 10° with respect to imaginary plane formed at a right-angled longitudinal axis of implant 200. The proximal end of implant 200 is flat surface 227.

FIG. 8 shows a side elevation view of another embodiment of an externally-threaded, tapered, one-piece endosseous dental implant 300. Implant 300 includes, on its external surface, first threaded region 312 and second threaded region 313. The distance between the thread flights in section 312 is approximately twice that of the distance between the threads in section 313. Proximal to section 313 is cylindrical, unthreaded external body portion 314 and circumferential groove 315.

Atop implant 300, and integral therewith, is angled head portion 319 that functions as an abutment. Portion 319 includes a tapered external surface 320 with cutouts/grooves 321 and 322, that are of size and shape to receive a snap-on transfer or snap-on comfort cap, such as those described above at page 3:9-12. Like the implant shown in FIGS. 1-5, implant 300 includes an internal passage that extends distally inside the implant 300 from an opening 324, near the proximal end of implant 300, and terminates inside the body of implant 300, with multi-sided, wrench-engaging surfaces formed near the distal end of the internal passage. These multi-sided surfaces are suitable for receiving and engaging a tool for twisting, turning, holding or inserting implant 300 into an opening formed in the jawbone of a patient to receive implant 300.

Abutment portion 319 forms an angled of approximately 10° with respect to imaginary plane formed at a right-angled longitudinal axis of implant 300. The proximal end of implant 300 is flat surface 327.

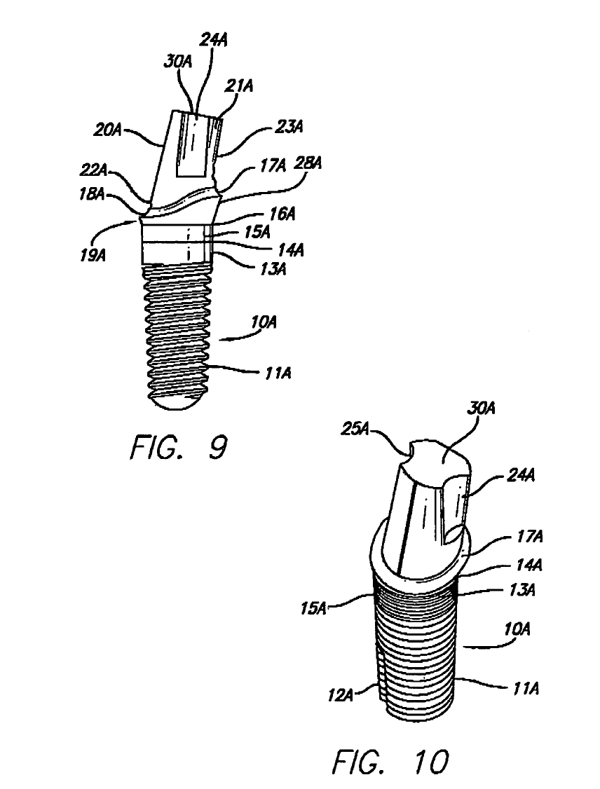

FIGS. 9 and 10 show side elevation and perspective views, respectively, of dental implant 10A. Implant 10A includes externally-threaded body region 11A with self-tapping cutting region 12A formed on the sidewall of external body portion 11A. Proximal to threaded body portion 11A is unthreaded, cylindrical body portion 13A. Groove 14A and cylindrical externally-unthreaded portion 15A are proximal to portion 13A.

Proximal to circumferential groove 16A is proximal, scalloped region 17A that includes scalloped shoulder 18A that extends proximally and upwardly from the front 19A of implant 10A toward the back 28A of implant 10A and, from there, extends distally toward the front of implant 10A from the back 28A.

Atop implant 10 is integral, tapered head portion 20A that functions as an abutment. Portion 20A includes tapered external surfaces 21A. Cutouts 22A and 23A, formed in the surface of tapered region 20A, are of size and shape to receive a snap-on transfer or snap-on comfort cap, such as those described above at page 3:9-12.

Tapered flat portion 20A also includes vertical grooves 24A and 25A that function as external wrench-engaging surfaces for gripping, twisting, turning, and holding implant 10A.

Abutment portion 20A forms an angle of approximately 10° with respect to imaginary plane formed at a right-angled to the longitudinal axis of implant 10A. The proximal end of implant 10A is flat surface 30A.

1. A one-piece endosseous implant comprising an externally-threaded body and, at the proximal end of said body, an angled portion that functions as an abutment.

2. The implant of claim 1, further comprising an internal passage in said implant, said passage extending distally from an opening in said abutment portion of the implant and extending distally inside, and ending inside said implant, said internal passage including multi-sided wrench-engaging surfaces for receiving and engaging a tool to twist, turn, hold or insert said implant in the jawbone of a patient.

3. The implant of claim 1 or claim 2, wherein said body is at least partially tapered from a proximal location toward a distal location.

4. The implant of claim 1 or claim 2, wherein said angled, proximal portion is tapered, and includes, at its distal end, a scalloped portion that extends upwardly from the front of the implant toward the back of the implant.

5. The implant of claim 1, or claim 2, further comprising a wholly or partly circumferential groove, formed on the external surface of the abutment portion of said implant, to receive and engage a protrusion formed inside a snap-on transfer component or a snap-on comfort cap that includes, on the inner surface of a distal cylindrical portion, said protrusion of size, shape and location appropriate to engage said groove.

6. The implant of claim 1, or claim 2, wherein said angled, proximal portion is tapered, and includes, at its distal end, a circumferential horizontal shoulder.

7. The implant of claim 6, wherein said body is at least partially tapered from a proximal location toward a distal location.

8. The implant of claim 1, or claim 2, wherein said angled, proximal portion is tapered, and includes, at its distal end, a shoulder that slants upwardly and proximally from the front of the implant toward the back of the implant.

9. The implant of claim 8, wherein said body is at least partially tapered from a proximal location toward a distal location.

10. The implant of claim 1, further comprising, on said angled portion, a plurality of grooves of size, shape, and location appropriate to twist, turn and hold the implant.
